(19) United States
(12) Patent Application Publication
(10) Pub. No.: US 2022/0340780 A1
(43) Pub. Date: Oct. 27, 2022

(54) Marking System for Rolled Materials that Distinguishes / Pinpoints the Location of each and Every Tear

(71) Applicant: Robert Alan Bard, Brielle, NJ (US)

(72) Inventor: Robert Alan Bard, Brielle, NJ (US)

(21) Appl. No.: 17/300,557

(22) Filed: Aug. 16, 2021

Related U.S. Application Data
(60) Provisional application No. 63/258,334, filed on Apr. 24, 2021.

(51) Int. Cl. C09J 7/00; A47K 10/16

(52) U.S. Cl. CPC C09J 7/00; A47K 10/16

(57) ABSTRACT

A system and method is described for marking materials in rolled form so as to overcome the problem of locating the starting point/location of said rolled material after a portion of said rolled material has been removed from the roll of said rolled material by distinguishing/pinpointing the location of every actual tear. The system and method overcomes personal frustration, wasted material and wasted time.

### PRIOR PUBLICATION DATA

### Provisional Patent Application Number: 63/258,334 Filing Date: Apr. 24, 2021

### ABSTRACT

A system and method is described for marking materials in rolled form so as to overcome the problem of locating the starting point/location of said rolled material after a portion of said rolled material has been removed from the roll of said rolled material by distinguishing/pinpointing the location of every actual tear. The system and method overcomes personal frustration, wasted material and wasted time.

### FIELD OF INVENTION

A marking system for rolled materials that distinguishes/pinpoints the location of every actual tear after a portion of said rolled material has been removed from said rolled material's roll thus saving personal frustration, wasted material and wasted time.

### BACKGROUND OF THE INVENTION

People have become frustrated and have wasted much material and much time trying to find the exact location of the actual tear on said rolled materials after a portion of the said rolled material has been removed from the roll of said rolled material.

### BRIEF DESCRIPTION OF THE DRAWINGS

FIGS. 1 through 4 all deal with the invention when the invention is paired with said rolled materials that are in the fully opaque state. When the invention is paired with said rolled materials that are in the transparent/clear state or the translucent state a verbal description only is provided.

FIG. 1 shows an example of the invention's varied applicability by first showing the invention's applicability to a roll of tape where the roll of tape is partially unraveled to best show on the upper surface of the tape that, by design, the position of what has been designated as the “telltale” marking is purposely designed to continue to vary in distance from each/either side of the tape and, for example and simplification purposes only, is shown as a single line in all figures. Also, for graphic purposes only, the “telltale” line is shown to be wider than all of the other lines in FIG. 1 in order to differentiate the “telltale” line from all other lines in FIG. 1 because the “telltale” line is at the heart of this invention. The unraveled portion of the tape is also shown still attached to the tape remaining on the roll of tape. The very end of the unraveled portion of the tape is the location where an actual separation of the tape occurred after the most previous/recent portion of the tape was torn off/removed from the roll of tape.

FIG. 2 shows a further example of the additional varied applicability of the invention by showing the invention's applicability to a roll of toilet paper where the roll of toilet paper is partially unraveled to best show that, by design, the position of what has been designated as the “telltale” line on the upper surface of the toilet paper purposefully continually varies in distance from each/either side edge of the toilet paper and additionally, for graphic purposes, the “telltale” line is shown to be wider than all of the other lines in FIG. 2 in order to differentiate the “telltale” line from all other lines in FIG. 2 because the “telltale” line is at the heart of the invention. The unraveled portion of the toilet paper is shown still attached to the toilet paper remaining on the roll of toilet paper. The very end of the unraveled portion of the toilet paper is the location where an actual separation of the toilet paper occurred after the most previous/recent portion of the toilet paper was torn off/removed from the roll of toilet paper.

FIG. 3 shows the same roll of tape as shown in FIG. 1, however, the unraveled portion of the tape is now reattached to the roll of tape showing both the location of an actual break in the “telltale” line which is the exact location of one point along the actual tear line of the tape, in other words, one point along the actual tear line of the tape that is left on the roll after the most previous/recent portion of the tape that was torn off/removed from the roll of tape as well as, at the same time, creating the optical illusion of what visually appears to be a break in a separate second “telltale” line showing but is, in fact, part of the one and the only “telltale” line leading to the creation of the following: a wavy line whose sole purpose via its waviness is to be differentiated from all other lines in FIG. 3 because the wavy line is the only line that represents an imaginary line connecting these two aforementioned closest break points which are, in fact, both created by the tearing of the tape and thus actually lying on the actual tear line. More specifically, the axial center line of the wavy line coincides exactly with a portion of the actual tear line as shown in FIG. 3.

FIG. 4 shows the same roll of toilet paper shown in FIG. 2, however, the unraveled portion of the toilet paper is now repositioned back against the roll of toilet paper showing both the location of the actual break in the “telltale” line which is the exact location of one point along the actual tear line of the toilet paper that is left on the roll of toilet paper after the most previous/recent portion of the toilet paper that was torn off/removed from the roll of toilet paper as well as, at the same time, creating the optical illusion of what visually appears to be a break in a separate second “telltale” line showing but is, in fact, part of the one and the only “telltale” line leading to the creation of the following: a wavy line whose sole purpose, via its waviness, is to be differentiated from all other lines in FIG. 4 because the wavy line is the only line that represents an imaginary line. More specifically, the axial centerline of the wavy line coincides exactly with a portion of the actual tear line as shown in FIG. 4.

### DETAILED DESCRIPTION OF INVENTION

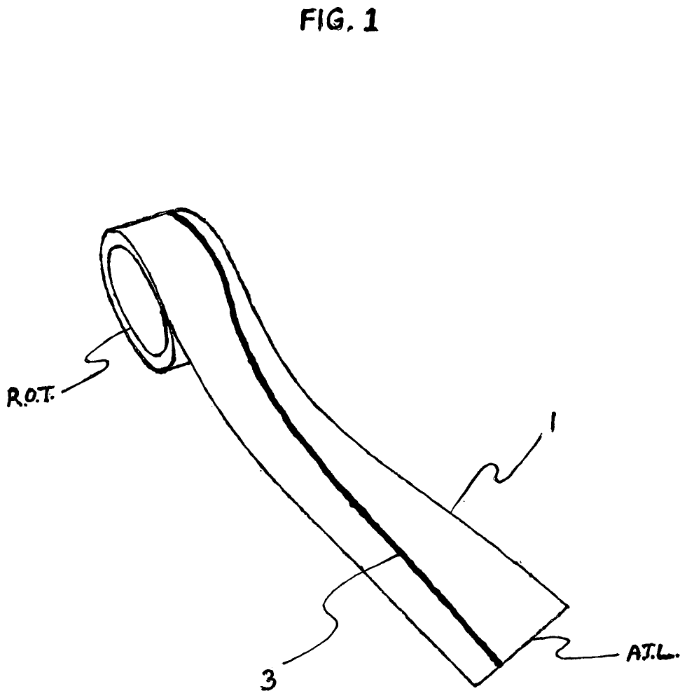

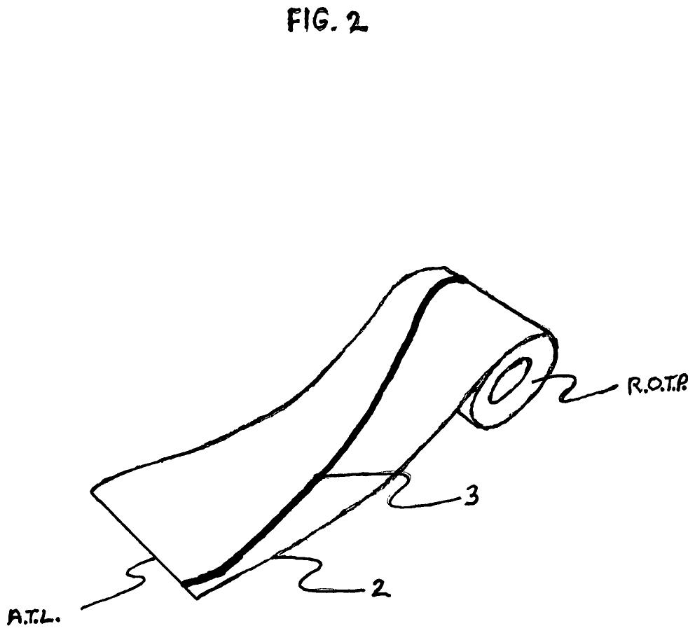

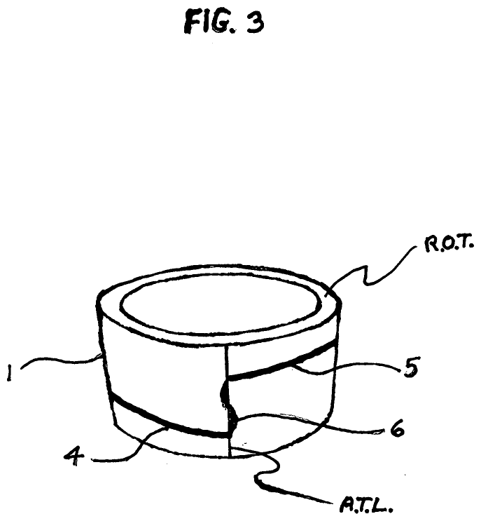

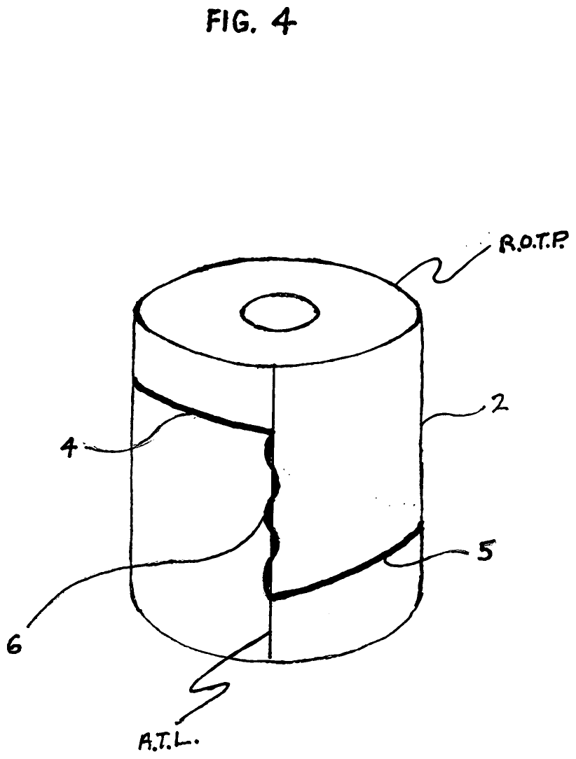

The utilitarian purpose of this invention is to help a person to more easily, efficiently and timely access the remaining end of an item such as tape (1) on a roll of tape (R.O.T.) as shown in FIGS. 1 and 3 or as toilet paper (2) on a roll of toilet paper (R.O.T.P.) as shown in FIGS. 2 and 4. In order to achieve the stated purpose of this invention as well as provide an understanding of how the invention works the following is provided: FIG. 1 shows a portion of the tape (1) partially unraveled from the roll of tape (R.O.T.) and FIG. 2 shows a portion of the toilet paper (2) partially unraveled from the roll of toilet paper (R.O.T.P.) following the most previous/recent removal of tape (1) or toilet paper(2) from their respective rolls allowing for the exposure of what lies at the heart of the invention which is a marking system that consists of a continuous “telltale” marking (3) continuously varying in distance from each/either side of such items as tape (1) or toilet paper (2) in turn creating the very special effect of the optical illusion of showing as two separate “telltale” markings (4) which is a sub-portion on the one and only “telltale” line (3) and which ends on the actual tear line (A.T.L.) and (5) which is also a sub-portion of the one and only “telltale” line (3) and which seems to appear as an end of a separate second “telltale” line but, in reality, is not the end of a separate second “telltale” line but rather, in reality, is still part of the one and only “telltale” line (3) and additionally which, having resulted from the actual tearing shows as having an end on the actual tear line (A.T.L.). The result of the foregoing is that an imaginary line connecting the two afore mentioned ends would also coincide with a portion of the actual tear line (A.T.L.). In this case the imaginary line is represented by the axial center line of the wavy line (6) which is purposely shown as being wavy in order to differentiate the wavy line (6) from all other lines on each figure because all other lines in each figure are associated with physical attributes while the imaginary line, itself, does not, by definition, have a physical attribute. All of the foregoing applies to material such as tape (1) and toilet paper (2) that are in the fully opaque state. At this point it is important to note that there are no figures that are employed to describe any of the following and therefore there are no corresponding numbers to relate any items in any figures. Relative to material such as tape which can also be in the transparent/clear/translucent state and toilet paper which can be in the translucent state the following applies concerning this invention: The tape or the toilet paper would incorporate a single “telltale” line composed of many bands/segments with each band/segment having a different color from that of each adjacent band/segment and in addition each band/segment being of the exact same length resulting in the following: after the most previous/recent portion of the tape or the toilet paper has been torn off/removed from their respective rolls the colors showing most prominently/brightest on each “telltale” line would be those colors lying on the outermost layer of the roll of the tape or the roll of the toilet paper when contrasted against/compared to the same colors that are lying as background below the outermost layer of the roll of either the tape or the toilet paper because of the outermost layer of either the roll of the tape or the roll of the toilet paper blocking some of light attempting to get through to the layers of the tape or the toilet paper located below the outermost layer of the tape or the toilet paper thus effectively muting the colors located on the single “telltale” line lying below the outermost layer of either the roll of tape or the roll of toilet paper. It is the combination of the afore mentioned muting of the colors located on the single “telltale” line lying below the outermost layer of either the roll of tape or the roll of toilet paper combined with the overlapping of the single “telltale” line in the layers of tape or toilet paper under the outermost layer of the tape or the toilet paper that yields an even/homogenous distribution of background coloring emanating from the many layers of tape or toilet paper under the outermost layer of tape or toilet paper that has in turn resulted in the following: the creation of the visual optical illusion of a roll of tape that is, in actuality, transparent/clear or translucent except for the continuous single “telltale” line but appears as a non transparent/non clear/non translucent roll of tape and also the visual optical illusion of a roll of toilet paper that is, in actuality, translucent except for the continuous single “telltale” line but appears as a non translucent roll of toilet paper. All of the foregoing leads to the vital fact that, based on solid statistics, it will be an extremely rare occasion, when each portion of tape or toilet paper is torn off from their respective rolls, that the actual tear will occur at exactly the intersection of any of the equal length color bands/segments of the continuous single “telltale” line but rather the tear will occur at a location within each color band/segment which, after the removal of a portion of the torn off tape or toilet paper from their respective rolls, will cause that band/segment which was subject to the actual tear to become shorter than all of the other bands/segments of the continuous single “telltale” line yielding the following: one of the two sides of that shortest band/segment of the continuous single “telltale” line will always coincide/line up with the actual tear line because the shortest band/segment of the continuous single “telltale” line only became the shortest band/segment of the continuous single “telltale” line because of the tearing off of a portion of the tape or the toilet paper from the roll of tape or the roll of toilet paper.

What we claim our invention is:

1. A method comprising: providing a rolled material comprising: a strip of rolled material having a certain width and thickness; marking said material with a continuous “telltale” line of a certain width, said “telltale” line being positioned diagonally or otherwise in relation to each/either side edge of the width of said material and extending the full length of said material so as to create a break in said “telltale” line on said material when a portion of said material is removed from said roll of material, thus distinguishing/pinpointing the end position of said material remaining on said roll of said material.

2. The process of claim 1 where in said material is completely opaque.

3. The process of claim 2 wherein said rolled material is marked in such a way as to delineate the starting point of said rolled material that is still attached to/left on/remaining on the roll of said rolled material following each and every removal of said rolled material from the roll of said rolled material.

4. The process of claim 3 wherein the marking comprises at least/at minimum a single “telltale” line of a contrasting color relative to the other color(s) that exist on the roll of said rolled material.

5. The process of claim 4 wherein said “telltale” line is positioned at varying distances from each/either side edge of said rolled material in addition to/separate from being in the form of a “telltale” line which was previously stated as being positioned diagonally or otherwise in relation to each/either side edge of the width of said rolled material:

6. The process of claim 5 wherein by continuously varying the positioning of the “telltale” line relative to the side edge of the width of said rolled material the following occurs after the actual tearing off of a portion of said rolled material from the roll of said material as follows:
first, the actual end point of the “telltale” line, by virtue of the afore mentioned actual tearing, coincides with the actual end point of the portion of said rolled material left/remaining on the roll of said rolled material and second, the actual end of said rolled material left/remaining on the roll of said rolled material covers another portion of the “telltale” line at another location along the length of the “telltale” line in turn causing the illusion of an appearance of a separate/second “telltale” existing on the roll of said rolled material. It is because the illusionary separate/second “telltale” line has been created by the afore mentioned actual tearing off of said rolled material that he end of the illusionary separate/second “telltale” line also lies on the actual tear line. Therefore, if a line is drawn connecting the actual end point of said rolled material left/remaining on the roll of said material and the illusionary end point of what seems to show as a separate/second “telltale” line, that line drawn will thus also coincide with a portion of the actual tear line.

7. A method comprising: providing a rolled transparent/clear or translucent material comprising: a strip of rolled material having a certain fixed width and thickness: marking the upper surface of said material with a visible continuous “telltale” marking, such as single “telltale” line composed of multiple bands/segments all attached to each other and all bands/segments being of equal length such that each and every band/segment has only one single color which is different from the color of each adjacent band/segment and furthermore such that said “telltale” line is also positioned diagonally or otherwise in relation to each/either side edge of the width of said material and extending the full length of said material so that an actual break in said material will, in turn, yield an actual break point in the continuity of said “telltale” line upon each and every removal of a portion of said material from the roll of said material resulting in the following: the colors showing most prominently/brightest on each said “telltale” line will be those colors lying on the said “telltale” line lying on the outermost layer of the roll of said material when contrasted against/compared to the same colors which are showing on the said “telltale” line and are lying below the outermost portion of the roll of said material because of the layer of said “telltale” line on the outermost portion of the roll of said material blocking some of the light from getting through to the layers of said “telltale” line on said material located below said “telltale” line located on the outermost portion of the roll of said material thus muting the colors on said “telltale” line lying below said “telltale” line located on the outermost layer of the roll of said material and when combined with the effect of the overlapping of said “telltale” line upon itself lying under the outermost portion of the roll of said material thus yielding an even/homogeneous distribution of muted coloring lying as background under said “telltale” line lying on the outermost layer of the roll of said material with all of the foregoing, in turn, resulting in the following: the creation of the visual optical illusion of roll of material that is actually transparent except for the said “telltale” line but appears as a non transparent/non clear roll of said material and the creation of the visual optical illusion of a roll of said material that is actually translucent except for the said “telltale line but appears as a non translucent roll of said material. All of the foregoing leads to the following: based on statistics there will only be an extremely rare occasion where as each portion of the said material is torn from their respective rolls that the actual tear will occur exactly at the intersection of any of the said equal length “telltale” line's color bands/segments, but rather will occur at a location which is within the length of one of the color bands/segments such that the removal of a portion of the length of the color band/segment that is subject to the tear will obviously cause the length of the remaining portion of that torn band/segment left on the roll of said material to be shorter than all other bands/segments remaining on the said “telltale” line yielding the following: one of the two sides of that shortest band/segment of the said “telltale” line will fall on the exact actual tear line because the shortest band/segment of the said “telltale” line only became the shortest band/segment of the said “telltale” line because of the tearing off of a portion of the said material from the roll of said material.

8. The process of claim 7 wherein said rolled material is marked in such a way as to delineate the starting point of said material that is still attached to/left on/remaining on the roll following each and every removal of said material from the roll of said material.

9. The process of claim 8 wherein the marking comprises at least/at minimum a single “telltale” line of contrasting color(s) relative to the transparency/clearness or translucence of said material.

10. The process of claim 9 wherein said “telltale line is positioned at varying distances from each/either side edge of said material in addition to/separate from being in the form of a “telltale” line which was previously stated as being positioned diagonally or otherwise in relation to each/either side edge of the width of said material.
